(19) United States
(12) Patent Application Publication
(10) Pub. No.: US 2007/0103417 A1
(43) Pub. Date: May 10, 2007

(54) Discharge display having three electrodes formed in a partition-wall plate of the display

(76) Inventors: Dong-Young Lee, Suwon-si (KR); Won-Ju Yi, Suwon-si (KR); Ho-Young Ahn, Suwon-si (KR); Kyoung-Doo Kang, Suwon-si (KR); Soo-Ho Park, Suwon-si (KR); Seok-Gyun Woo, Suwon-si (KR); Jae-Ik Kwon, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/525,559

(22) Filed: Sep. 21, 2006

(30) Foreign Application Priority Data
Nov. 7, 2005 (KR) 10-2005-0106024

(51) Int. Cl. G09G 3/36

(52) U.S. Cl. 345/89

(57) ABSTRACT

A discharge display apparatus having a discharge display panel and a driving device that drives the discharge display panel is disclosed. The discharge display panel includes a partition-wall plate, address electrodes, common electrodes, and scan electrodes. The partition-wall plate has through-cells and is disposed between first and second substrates. The address electrodes, the common electrodes, and the scan electrodes are all ring-shaped electrodes which surround the through-cells and are disposed in the partition-wall plate. The driving device divides a single frame into a plurality of subfields and performs addressing and sustaining operations in a single subfield. The addressing operation is performed by driving the address electrodes and the scan electrodes, and the sustaining operation is performed by driving the common electrodes and the scan electrodes.

### CROSS-REFERENCE TO RELATED PATENT APPLICATION

The application claims the benefit of Korean Patent Application No. 10-2005-0106024, filed on Nov. 7, 2005, in the Korean Intellectual Property Office, the disclosure of which is incorporated herein in its entirety by reference.

### BACKGROUND OF THE INVENTION

1. Field of the Invention

The present invention relates to a discharge display apparatus, and more particularly to, a discharge display apparatus having a three-electrode type discharge display panel and a driving device for driving the discharge display panel.

2. Description of the Related Technology

FIG. 1 is an exploded perspective view of a conventional plasma display panel 100 having a three-electrode type surface discharge structure, as disclosed in U.S. Pat. No. 6,903,709.

The plasma display panel 100 includes a first substrate 101, common electrodes 106, scan electrodes 107, a first dielectric layer 109, a protective layer 111, a second substrate 115, address electrodes 117, a second dielectric layer 113, barrier ribs 114, and a phosphor layer 110.

The common electrodes 106 and the scan electrodes 107 are covered by the first dielectric layer 109. The first dielectric layer 109 is covered by the protective layer 111. The second substrate 115 is disposed to face the first substrate 101. The address electrodes 117 are arranged parallel to each other on the second substrate 115. The address electrodes 117 are covered by the second dielectric layer 113. The barrier ribs 114 are formed on the second dielectric layer 113. The phosphor layer 110 is formed to cover an upper surface of the second dielectric layer 113 and sidewalls of the barrier ribs 114.

The conventional plasma display panel 100 has certain problems.

A large portion (about 40%) of visible rays emitted from the phosphor layer 110 are absorbed by the common electrodes 106, the scan electrodes 107, the first dielectric layer 109, and the protective layer 111 at the bottom of the first substrate 101, thereby lowering the luminous efficiency of the conventional plasma display panel 100.

Also, when the same image is displayed in the conventional plasma display panel 100 for a long period of time, the phosphor layer 110 is ion-sputtered by charged particles of discharge gas, thereby causing image sticking.

### SUMMARY OF THE CERTAIN INVENTIVE ASPECTS

The present invention provides a discharge display apparatus having a discharge display panel that increases the luminous efficiency of the discharge display apparatus and prevents image sticking, and a driving device that digitally drives the discharge display panel.

One embodiment is a discharge display apparatus including a discharge display panel, and a driving device configured to drive the discharge display panel. The discharge display panel includes a partition-wall plate having a plurality of through-cells and being disposed between a first substrate and a second substrate, a plurality of address electrodes, a plurality of common electrodes, and a plurality of scan electrodes, where each electrode is located within the partition-wall plate and substantially surrounds a through-cell. The driving device is configured to divide a single frame into a plurality of subfields, and to perform an addressing operation and a sustaining operation within a single subfield, where the driving device is configured to perform the addressing operation by driving the address electrodes and the scan electrodes, and the driving device is configured to perform the sustaining operation by driving the common electrodes and the scan electrodes.

Another embodiment is a discharge display apparatus including a discharge display panel, and a driving device configured to drive the discharge display panel. The discharge display panel includes a first substrate, a second substrate facing the first substrate, a partition-wall plate having through-cells and being disposed between the first and second substrates, and a plurality of address electrodes located in the partition-wall plate, where each address electrode substantially surrounds one or more of the through-cells. The panel also includes a plurality of common electrodes located in the partition-wall plate, each common electrode substantially surrounding one or more of the through-cells, where the common electrodes cross the address electrodes and are disposed between the first substrate and the address electrodes. The panel also includes a plurality of scan electrodes in the partition-wall plate, each common electrode substantially surrounding one or more of the through-cells, where the scan electrodes cross the address electrodes and are disposed between the second substrate and the address electrodes. The driving device is configured to divide a single frame into a plurality of subfields, and to perform an addressing operation and a sustaining operation within a single subfield, where the driving device is configured to perform the addressing by driving the address electrodes and the scan electrodes, and the driving device is configured to perform the sustaining operation by driving the common electrodes and the scan electrodes.

Another embodiment is a discharge display including a display panel, the display panel including a partition-wall plate having a plurality of through-cells and being disposed between a first substrate and a second substrate. The panel also includes a plurality of address electrodes, a plurality of common electrodes, and a plurality of scan electrodes, where each electrode is located within the partition-wall plate and substantially surrounds a through-cell.

### BRIEF DESCRIPTION OF THE DRAWINGS

The above and other features and advantages will become more apparent in the description of certain embodiments with reference to the attached drawings in which:

FIG. 1 is an exploded perspective view of a conventional plasma display panel having a three-electrode surface discharge structure;

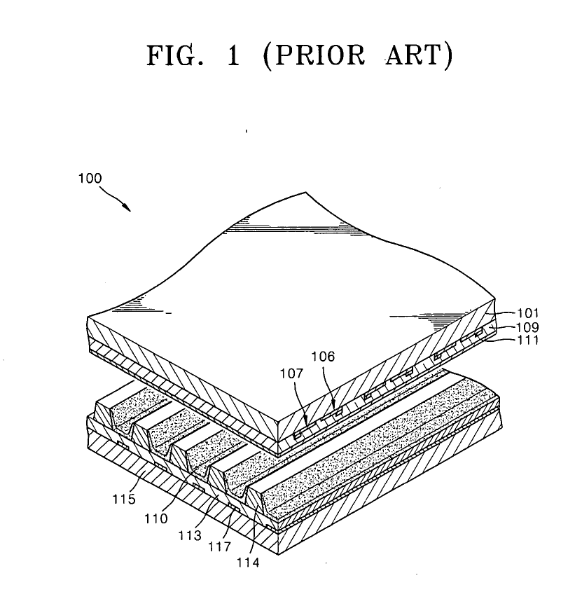

FIG. 2 is an exploded perspective view of a ring-type three-electrode plasma display panel included in a discharge display apparatus according to an embodiment;

FIG. 3 is a cross-sectional view of the plasma display panel taken along a line V—V of FIG. 2;

FIG. 4 is a perspective view of an array of through-cells and electrodes shown in FIGS. 2 and 3, according to an embodiment;

FIG. 5 is a block diagram of a driving device that drives the ring-type three-electrode plasma display panel illustrated in FIG. 2, according to an embodiment;

FIG. 6 is a timing diagram of a method of driving the ring-type three-electrode plasma display panel illustrated in FIG. 2 in a single frame using the driving device of FIG. 5, according to an embodiment;

FIG. 7 is a timing diagram of a method of driving the ring-type three-electrode plasma display panel illustrated in FIG. 2 in a single subfield of FIG. 6 using the driving device of FIG. 5, according to an embodiment;

### DETAILED DESCRIPTION OF CERTAIN INVENTIVE EMBODIMENTS

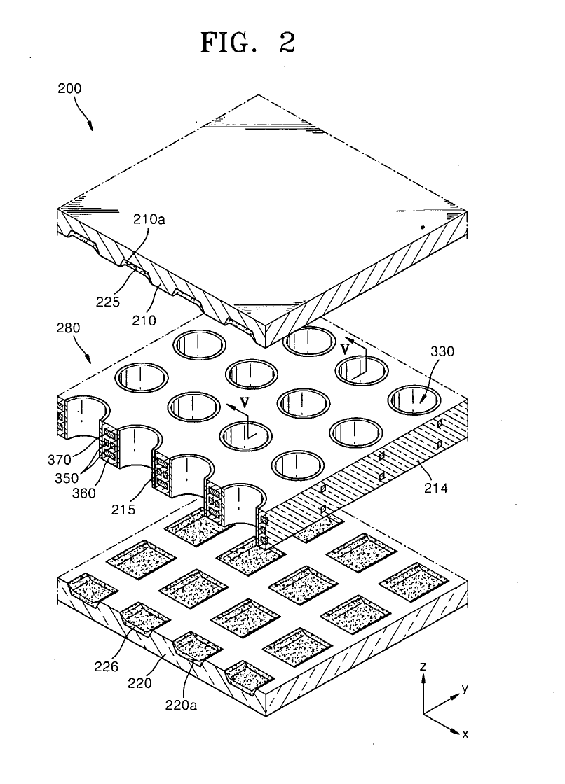

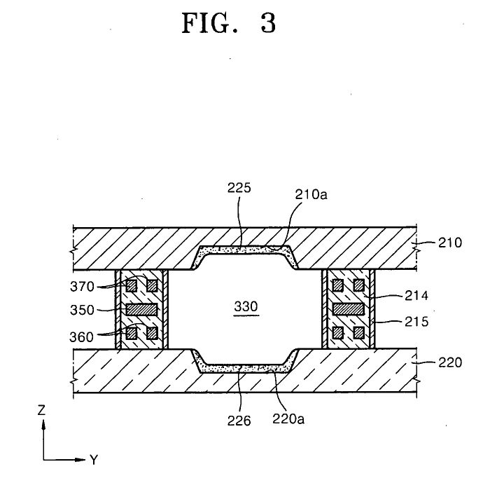

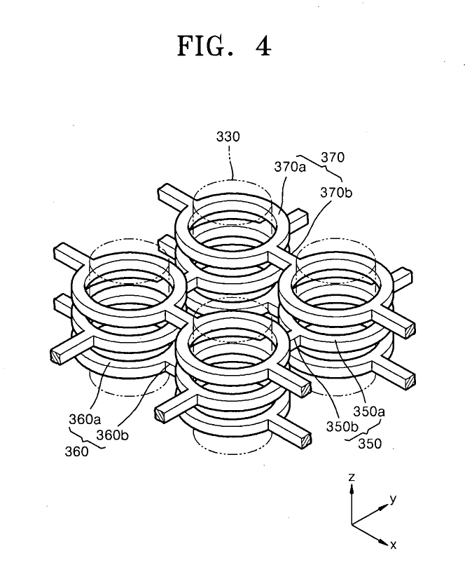

FIG. 2 is an exploded perspective view of a ring-type three-electrode plasma display panel 200 included in a discharge display apparatus according to an embodiment. FIG. 3 is a cross-sectional view of the plasma display panel 200 of FIG. 2, taken along a line V—V according to an embodiment. FIG. 4 is a perspective view of an array of through-cells 330 and address electrodes 350, scan electrodes 360, and common electrodes 370 illustrated in FIGS. 2 and 3 according to an embodiment.

Referring to FIGS. 2 through 4, the plasma display panel 200 includes a first substrate 210, a second substrate 220, a partition-wall plate 280, the address electrodes 350, the scan electrodes 360, the common electrodes 370, a first phosphor layer 225, a second phosphor layer 226, and protective layers 215.

The first and second substrates 210 and 220 are formed of a material having high light transmissivity, which may comprise glass as a major constituent thereof. The second substrate 220 is disposed to face the first substrate 210 at a distance from the first substrate 210. The first and second substrates 210 and 220 may be formed of substantially the same material. In this case, a coefficient of thermal expansion of the first substrate 210 is substantially the same as a coefficient of thermal expansion of the second substrate 220.

The partition-wall plate 280 includes through-cells 330 and a partition wall 214, and is disposed between the first and second substrates 210 and 220. According to an embodiment, a cross-section of the through-cells 330 is circular in shape but the shape of the cross-section of the through-cells 330 is not limited to this and may, for example, be triangular, rectangular, pentagonal, oval, or other shapes.

The address electrodes 350 have apertures corresponding to the through-cells 330 and are located in the partition wall 214 and are disposed within the partition wall 214 of the partition-wall plate 280. The address electrodes 350 extend in a second direction, along a y-axis, perpendicular to a first direction, along an x-axis, in which the common electrodes 370 and the scan electrodes 360 extend. Also, the address electrodes 350 are disposed in the partition-wall plate 280, between the common electrodes 370 and the scan electrodes 360, in a third direction along a z-axis. As shown in FIG. 4, the address electrodes 350 include first loop units 350a respectively surrounding the through-cells 330, and first loop connectors 350b connected to the first loop units 350a.

The common electrodes 370 have apertures corresponding to the through-cells 350 and are disposed between the first substrate 210 and the address electrodes 350 within the partition wall 214 and inside the partition-wall plate 280. The common electrodes 370 extend in the first direction (x-axis direction) and cross the address electrodes 350 which extend in the second direction (y-axis direction). As shown in FIG. 4 the common electrodes 370 include first loop units 370a respectively surrounding the through-cells 330, and first loop connectors 370b connected to the first loop units 370a.

As shown in FIG. 3, in the first substrate 210, grooves 210a are respectively formed in regions corresponding to the through-cells 330, and the first phosphor layer 225 is formed in the grooves 210a.

The protective layers 215 are formed to cover sidewalls of the through-cells 330. The protective layers 215 prevent the partition wall 214, the address electrodes 350, the scan electrodes 360, and the common electrodes 370 from being damaged by plasma particle sputtering, and emitting secondary electrons to lower a firing discharge voltage. The protective layers 215 may be formed by applying MgO on sides of the partition wall 214.

Since the address electrodes 350, the scan electrodes 360, and the common electrodes 370 are embedded into the partition wall 214 in the partition-wall plate 280, the partition wall 214 may be formed of a dielectric that can induce electric charges to accumulate wall charges.

In the ring-type three-electrode plasma display panel 200, the address electrodes 350, the common electrodes 370, and the scan electrodes 360 have advantages because they are at least partially surround the through-cells 330 and are disposed in the partition-wall plate 280.

One advantage is that additional dielectric layers for the address electrodes 350, the scan electrodes 360 and the common electrodes 370 are not needed, and discharge spaces are formed in the through-cells 330. Thus, visible rays generated by discharge in the through-cells 330 are emitted directly, thereby increasing the luminous efficiency of the plasma display panel 200.

Another advantage is that the address electrodes 350, the common electrodes 370, and the scan electrodes 360 are all ring-shaped electrodes which surround the through-cells 330, and thus, electric fields from the address electrodes 350, the scan electrodes 360 and the common electrodes 370 are focused on the centers of the through-cells 330. Accordingly, even if the same image is displayed in the plasma display panel 200 for a long period of time, the phosphor layers 225 and 226 are not ion-sputtered by charged particles of discharge gas, thereby preventing image sticking.

Another advantage is that since the address electrodes 350, the common electrodes 370, and the scan electrodes 360 are all ring-shaped electrodes which surround the through-cells 330, discharge can occur throughout substantially the entirety of each of the through-cells 330. Thus, the discharge response speed and the discharge efficiency of the plasma display panel 200 are increased.

Another advantage is that the address electrodes 350, the scan electrodes -360, and the common electrodes 370 are formed on the sides of the through-cells 330, as opposed to the conventional placement on the first and second substrates 210 and 220 through which visible rays are required to pass. Therefore, the address electrodes 350, the scan electrodes 360, and the common electrodes 370 need not be formed of a transparent conductor, such as Indium-Tin-Oxide (ITO) which has a large resistance. Thus, the address electrodes 350, the scan electrodes 360, and the common electrodes 370 may be formed of metal having a small resistance, thereby increasing the discharge response speed and the discharge efficiency of the plasma display panel 200.

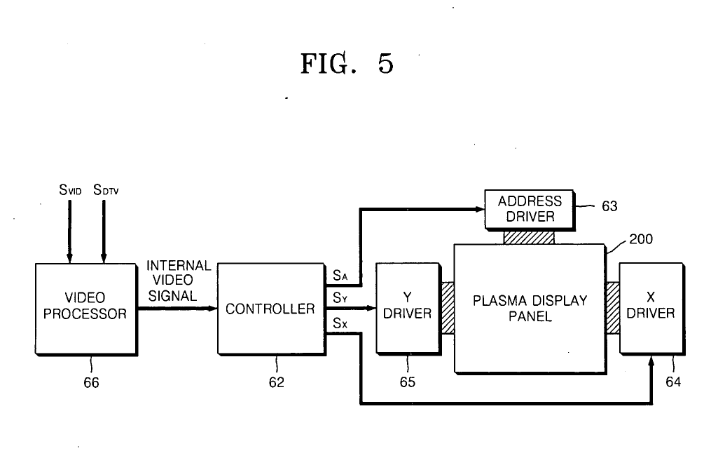

FIG. 5 is a block diagram of a driving device that drives the ring-type three-electrode plasma display panel 200 illustrated in FIG. 2, according to an embodiment of the present invention. Referring to FIG. 5, the driving device includes a video processor 66, a controller 62, an address driver 63, an X driver 64, and a Y driver 65.

The video processor 66 transforms external video signals, e.g., a video signal SVID and a digital-television (TV) signal SDTV, into internal digital video signals. Examples of the internal digital video signals include 8-bit red (R), green (G), and blue (B) video data, a clock signal, a vertical synchronization signal, and a horizontal synchronization signal.

The controller 62 generates data signals SA, X control signals SX, and Y control signals SY in response to the internal video signals from the video processor 66.

The address driver 63 drives the address electrodes 350 of the plasma display panel 200 in response to the data signals SA from the controller 62. The X driver 64 drives the common electrodes 370 of the plasma display panel 200 in response to the X control signals SX from the controller 62. The Y driver 65 drives the scan electrodes 360 of the plasma display panel 200 in response to the Y control signals SY from the controller 62.

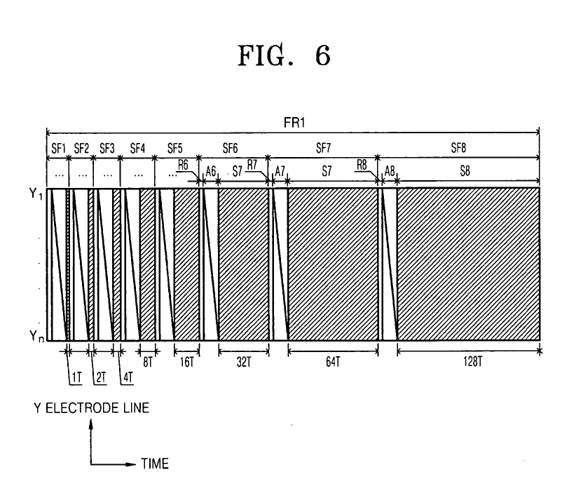

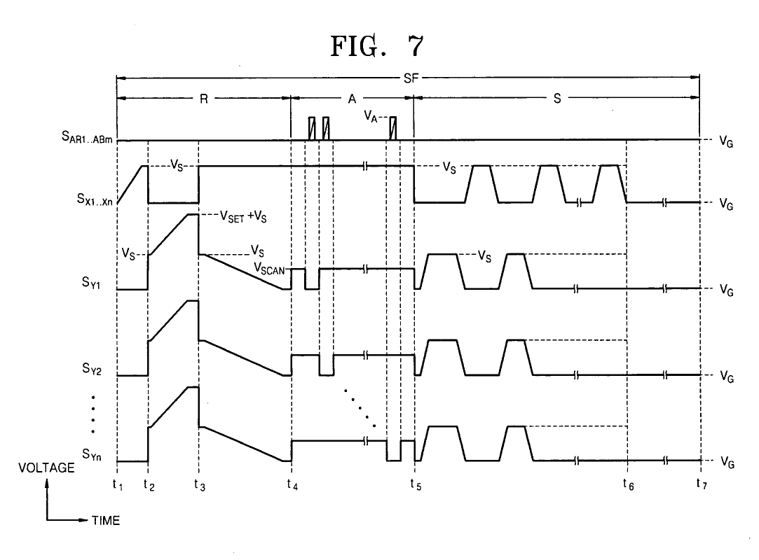

The driving device divides a single frame into a plurality of subfields, and performs addressing and sustaining operations in single subfields. Specifically, the driving device performs the addressing operation by driving the address electrodes 350 and the scan electrodes 360, and performs the sustaining operation by driving the common electrodes 370 and the scan electrodes 360. Thus, since time-division driving in a single frame is possible, the ring-type three-electrode plasma display panel 200 can be digitally driven, which will now be described with reference to FIGS. 6 and 7.

FIG. 6 is a timing diagram of a method of driving the ring-type three-electrode plasma display panel 200 using the driving device of FIG. 5 in a single frame FR1. In FIG. 6, reference numerals Y1 through Yn denote the scan electrodes 360 of FIG. 2 that are sequentially scanned.

As illustrated in FIG. 6, each single frame is divided into eight subfields SF1, . . . , SF8 to obtain a time-ratio gray-scale control display, wherein the single frame is divided into the plurality of the subfields so that the time of each of the subfields is substantially proportional to an applied gray-scale weight. In some embodiments, the driving single frame is divided into the plurality of subfields so that a period of time for the sustaining operation in each of the subfields is substantially proportional to the applied given gray-scale weight.

Also, each of the subfields SF1, . . . , SF8 is divided into initialization periods R1, . . . , R8, address periods A1, . . . , A8, and sustain periods S1, . . . , S8.

Discharge conditions in all of the through-cells 330 of FIG. 2 are controlled to be suitable for addressing which is performed after the through-cells 330 are initialized in each of the initialization periods R1, . . . , R8.

In each of the address periods A1, . . . , A8, display data signals are sequentially supplied to the address electrodes 350, while scan pulses are sequentially supplied to the scan electrodes Y₁, . . . , Yₙ 360. Wall charges are formed in corresponding through-cells 330 when logic high display data signals are applied to the corresponding through-cells 330 during application of the scan pulses.

In each of the sustain periods S1, . . . , S8, sustain-discharge pulses are alternately applied to the scan electrodes Y₁, . . . , Yₙ 360 and the common electrodes 370, thus causing display discharge in the through-cells 330 in which the wall charges have been formed in the corresponding address period A1, . . . , or A8. Thus, the brightness of the emitted light in the respective through-cells 330 in the plasma display panel 200 is proportional to the length of each of the sustain periods S1, . . . , S8 of the single frame FR1. The total length of the sustain periods S1, . . . , S8 of the single frame FR1 is 255T where T denotes a unit of time. Therefore, it is possible to display 256 gray scales including a zero gray scale during which no light is emitted in the single frame FR1.

In FIG. 6, 1T, corresponding to 2⁰, is set for the sustain period S1 of the first subfield SF1. 2T, corresponding to 2¹, is set for the sustain period S2 of the second subfield SF2. 4T, corresponding to 2², is set for the sustain period S3 of the third subfield SF3. 8T, corresponding to 2³, is set for the sustain period S4 of the fourth subfield SF4. 16T, corresponding to 2⁴, is set for the sustain period S5 of the fifth subfield SF5. 32T, corresponding to 2⁵, is set for the sustain period S6 of the sixth subfield SF6. 64T, corresponding to 2⁶, is set for the sustain period S7 of the seventh subfield SF7. 128T, corresponding to 2⁷, is set for the sustain period S8 of the eighth subfield SF8.

Therefore, if a subfield to be displayed is properly selected from the eight subfields SF1 through SF8, a time-division display with 256 gray scales can be obtained.

FIG. 7 is a timing diagram of a method of driving the ring-type three-electrode plasma display panel 200 illustrated in FIG. 2 during a single subfield SF, which is one of the subfields SF1 through SF8 of FIG. 6, using the driving device of FIG. 5. In FIG. 7, reference numerals S_{AR1}, . . . , _{ABm} denote driving signals supplied to the address electrodes 350 of FIG. 2, reference numerals S_{X1}, . . . , _{Xn} denote driving signals supplied to the common electrodes 370 of FIG. 2, and reference numerals S_{Y1}, . . . , S_{Yn} denote driving signals supplied to the scan electrodes 360 of FIG. 2 (or the scan electrodes Y₁, . . . , Yₙ of FIG. 6).

Referring to FIG. 7, during a first period from t₁, to t₂, a voltage applied to the common electrodes 370 is increased from a ground voltage V_{G} to a second voltage V_{S} in an initialization period R of the single subfield SF. During the initialization period, the ground voltage V_{G} is applied to the scan electrodes 360 and the address electrodes 350. Thus, a weak discharge occurs in a discharge region between the common electrodes 370 and the scan electrodes 360 Y₁, . . . , Yₙ, and in a discharge region between the common electrodes 370 and the address electrodes 350, and thus, negative wall charges are formed around the common electrodes 370.

During a second period, from t₂ to t₃, in the initialization period R where wall charges are accumulated, a voltage applied to the scan electrodes 360 Y₁, . . . , Yₙ is continuously increased from the second voltage V_{S} to a first voltage V_{SET}+V_{S} that is higher by a fourth voltage V_{SET} than the second voltage V_{S}. During this period, the ground voltage V_{G} is applied to the common electrodes 370 and the address electrodes 350. Thus, a weak discharge continues to occur in the discharge region between the scan electrodes 360 Y₁, . . . , Yₙ and the common electrodes 370, and in a discharge region between the scan electrodes 360 Y₁, . . . , Yₙ and the address electrodes 350. Accordingly, a large amount of negative wall charges are formed around the scan electrodes 360 Y₁, . . . , Yₙ, and a large amount of positive wall charges are formed around the common electrodes 370 and the address electrodes 350.

During a third period, from t₃ to t₄, in the initialization period R when wall charges are all present, a voltage applied to the scan electrodes 360 Y₁, . . . , Yₙ is continuously reduced from the second voltage V_{S} to the ground voltage V_{G}, i.e., a third voltage, while a voltage applied to the common electrodes 370 is maintained at the second voltage V_{S}. During this period, the ground voltage V_{G} is applied to the address electrodes 350. Thus, a weak discharge continuously occurs in the discharge region between the address electrodes 370 and the scan electrodes 360 Y₁, . . . , Yₙ, and thus, some of the negative wall charges accumulated around the scan electrodes 360 Y₁, . . . , Yₙ move to surround the common electrodes 370. Accordingly, the wall electric-potential of the common electrodes 370 is lower than that of the address electrodes 350 but is higher than that of the scan electrodes 360 Y₁, . . . , Yₙ. During this period, an address voltage V_{A}-V_{G} needed for an opposed discharge between the address electrodes 350 and the scan electrodes 360 Y₁, . . . , Yₙ selected during the earlier address period A, may be lowered.

During the earlier address period A, display data signals are respectively supplied to the address electrodes 350, and scan pulses having the ground voltage V_{G} are sequentially applied to the scan electrodes 360 Y₁, . . . , Yₙ that are biased to a fifth voltage V_{SCAN} lower than the second voltage Vₛ, thereby performing advantageous addressing. If the through-cells 330 of FIG. 2 are selected, a positive address voltage V_{A} is applied to the display data signals that are respectively applied to the address electrodes 350. If the through-cells 330 of FIG. 2 are not selected, the ground voltage V_{G} is applied to the display data signals respectively applied to the address electrodes 350. While scan pulses of the ground voltage V_{G} are applied, the display data signals having the positive address voltage V_{A} are supplied, address discharge forms wall charges in only the corresponding through-cell 330. For more precise and efficient address discharge, the common electrodes 370 X₁, . . . , Xₙ are maintained at the second voltage V_{S}.

During a sustain period S subsequent to the address period A, sustain pulses of the second voltage V_{S} are alternately applied to all of the scan electrodes 360 Y₁, . . . , Yₙ and the common electrodes 370, thus causing sustain discharge in the corresponding through-cells 330 where the wall charges are formed during the address period A.

As described above the plasma display panel 200 of FIG. 2 can be digitally driven with time-division driving during a single frame.

As described above, a discharge display apparatus according to an embodiment in which address electrodes, common electrodes, and scan electrodes are all ring-shaped electrodes which surround through-cells and are disposed in a partition-wall plate has advantages.

One advantage is that additional dielectric layers for electrodes are not needed and discharge regions are formed in the through-cells, and thus, visible rays generated due to discharge in the through-cells are emitted directly, thereby increasing the luminous efficiency of the discharge display apparatus.

Also, electric fields of the electrodes are focused on the centers of the through-cells. Thus, even if the same image is displayed in the discharge display apparatus for a long amount of time, a phosphor layer is not ion-sputtered by charged particles of discharge gas, thereby preventing image sticking.

Furthermore, discharge can occur throughout each of the through-cells, thereby increasing the discharge response speed and the discharge efficiency of the discharge display apparatus.

Also, the electrodes are disposed on the sides of the through-cells that are discharge regions, not first and second substrates through which visible rays pass. Therefore, the address, scan and common electrodes need not be formed of a transparent conductor that has a large resistance. Thus, the address, scan and common electrodes can be formed of metal having a small resistance, thereby increasing the discharge response speed and the discharge efficiency of the discharge display apparatus.

A driving device, of a discharge display apparatus according to an embodiment divides a single frame into a plurality of subfields and performs addressing and sustaining operations in a single subfield. Specifically, the addressing operation is performed by driving address electrodes and scan electrodes, and the sustaining operation is performed by driving common electrodes and scan electrodes. Therefore, time-division driving can be performed within a single frame, and thus, a discharge display panel can be digitally driven. While the present invention has been particularly shown and described to embodiments thereof, it will be understood by those of ordinary skill in the changes in form and details may be made therein without departing from the of the present invention.

What is claimed is:

1. A discharge display apparatus comprising:
a discharge display panel; and
a driving device configured to drive the discharge display panel,
wherein the discharge display panel comprises:
a partition-wall plate having a plurality of through-cells and being disposed between a first substrate and a second substrate; and
a plurality of address electrodes, a plurality of common electrodes, and a plurality of scan electrodes, wherein each electrode is located within the partition-wall plate and substantially surrounds a through-cell, and wherein
the driving device is configured to divide a single frame into a plurality of subfields, and to perform an addressing operation and a sustaining operation within a single subfield,
wherein the driving device is configured to perform the addressing operation by driving the address electrodes and the scan electrodes, and the driving device is configured to perform the sustaining operation by driving the common electrodes and the scan electrodes.

2. The discharge display apparatus of claim 1, wherein a protective layer is located on one or more sidewalls of each of the through-cells.

3. The discharge display apparatus of claim 1, wherein the through-cells have a substantially circular cross section.

4. A discharge display apparatus comprising:
a discharge display panel; and
a driving device configured to drive the discharge display panel,
wherein the discharge display panel comprises:
a first substrate;
a second substrate facing the first substrate;
a partition-wall plate having through-cells and being disposed between the first and second substrates;
a plurality of address electrodes located in the partition-wall plate, wherein each address electrode substantially surrounds one or more of the through-cells;
a plurality of common electrodes located in the partition-wall plate, each common electrode substantially surrounding one or more of the through-cells, wherein the common electrodes cross the address electrodes and are disposed between the first substrate and the address electrodes; and
a plurality of scan electrodes in the partition-wall plate, each common electrode substantially surrounding one or more of the through-cells, wherein the scan electrodes cross the address electrodes and are disposed between the second substrate and the address electrodes, and
the driving device is configured to divide a single frame into a plurality of subfields, and to perform an addressing operation and a sustaining operation within a single subfield,
wherein the driving device is configured to perform the addressing by driving the address electrodes and the scan electrodes, and the driving device is configured to perform the sustaining operation by driving the common electrodes and the scan electrodes.

5. The discharge display apparatus of claim 4, wherein the through-cells have a substantially circular cross section.

6. The discharge display apparatus of claim 4, wherein, at least one of the first and second substrates includes a groove formed in each of a plurality of regions corresponding to the through-cells, and a phosphor layer is located in the groove.

7. The discharge display apparatus of claim 6, wherein a protective layer is located on one or more sidewalls of each of the through-cells.

8. The discharge display apparatus of claim 4, wherein the driving device is configured to perform an initialization operation to set initial conditions of the through cells before an addressing operation in the single subfield.

9. The discharge display apparatus of claim 8, wherein the driving device is configured to discharge wall charges in the through-cells during the initialization operation, to generate wall charges in the through-cells during the addressing operation, and to cause a sustain discharge to occur in the through-cells during the sustaining operation.

10. The discharge display apparatus of claim 4, wherein the driving device is configured to divide the single frame into the plurality of the subfields so that a period of time of each of the subfields is substantially proportional to an applied gray-scale weight.

11. The discharge display apparatus of claim 10, wherein the driving device is configured to divide the single frame into the plurality of subfields so that a period of time for the sustaining operation in each of the subfields is substantially proportional to an applied given gray-scale weight.

12. A discharge display including a display panel, the display panel comprising:
a partition-wall plate having a plurality of through-cells and being disposed between a first substrate and a second substrate; and
a plurality of address electrodes, a plurality of common electrodes, and a plurality of scan electrodes, wherein each electrode is located within the partition-wall plate and substantially surrounds a through-cell.

13. The discharge display of claim 12, wherein the through-cells have a substantially circular cross-section.

14. The discharge display of claim 12, further comprising a driving device configured to drive the display panel, wherein the driving device is configured to divide a single frame into a plurality of subfields, and is configured to perform an addressing operation and a sustaining operation within a single subfield, wherein the driving device is configured to perform the addressing operation by driving the address electrodes and the scan electrodes, and the driving device is configured to perform the sustaining operation by driving the common electrodes and the scan electrodes.

15. The discharge display apparatus of claim 12, wherein at least one of the first and second substrates includes a groove formed in each of a plurality of regions corresponding to the through-cells, and a phosphor layer is located in the groove.

16. The discharge display apparatus of claim 12, wherein a protective layer is formed on one or more sidewalls of each of the through-cells.

17. The discharge display apparatus of claim 14, wherein the driving device is configured to perform an initialization operation to set initial conditions of the through cells before an addressing operation in the single subfield.

18. The discharge display apparatus of claim 17, wherein the driving device is configured to discharge wall charges in the through-cells during the initialization operation, to generate wall charges in the through-cells during the addressing operation, and to cause a sustain discharge to occur in the through-cells during the sustaining operation.

19. The discharge display apparatus of claim 14, wherein the driving device is configured to divide the single frame into the plurality of the subfields so that a period of time of each of the subfields is substantially proportional to an applied gray-scale weight.

20. The discharge display apparatus of claim 14, wherein the driving device is configured to divide the single frame into the plurality of subfields so that a period of time for the sustaining operation in each of the subfields is substantially proportional to an applied given gray-scale weight.
